(19) United States
(12) Patent Application Publication
(10) Pub. No.: US 2026/0070770 A1
(43) Pub. Date: Mar. 12, 2026

(54) TOOL WITH INTERCHANGEABLE HEAD

(71) Applicant: Hong Ann Tool Industries Co., Ltd., Taichung City (TW)

(72) Inventor: Cheng-Wei SU, Taichung City (TW)

(21) Appl. No.: 19/387,047

(22) Filed: Nov. 12, 2025

Related U.S. Application Data
(63) Continuation-in-part of application No. 19/037,520, filed on Jan. 27, 2025.

(30) Foreign Application Priority Data
Apr. 30, 2024 (TW) 113116177

(51) Int. Cl. B66F 15/00; B25G 3/18

(52) U.S. Cl. CPC B66F 15/00; B25G 3/18

(57) ABSTRACT

A tool with an interchangeable head includes a handle, a tool head, and a joining mechanism. The tool head is detachably connected to the handle and has a body extending along a first axis and an abutting portion extending along a second axis. The first axis and the second axis intersect to form an offset angle ranging from 30 degrees to 105 degrees. The joining mechanism is disposed between the handle and the tool head and is configured to selectively permit or restrict the tool head from being detached from the handle.

### CROSS-REFERENCE TO RELATED APPLICATIONS

The present application is a continuation-in-part of U.S. patent application Ser. No. 19/037,520, filed on Jan. 27, 2025, now pending, which claims the benefit of priority to Taiwan Patent Application No. 113116177, filed on Apr. 30, 2024, now issued as Taiwan Patent No. I874207, the entire disclosure of which is incorporated herein by reference in its entirety for all purposes.

### BACKGROUND OF THE INVENTION

The present invention relates to hand tools, and more particularly, to a tool with an interchangeable head mechanism that enables quick and easy head replacement without the need for additional tools.

Taiwan Patent No. M647545 discloses a hand tool that comprises a connecting rod, a sleeve with a non-circular recessed portion, and a hole passing through the sleeve wall connecting to the recessed portion. A fastener engages the hole and extends into the recessed portion. The tool also comprises a pry bar assembly with multiple pry heads of different functional shapes and connecting rods. Each rod is connected to a pry head and has an insertion end with a narrower neck portion and a groove around the neck portion. The insertion end faces the recessed portion, allowing the rod to be inserted and preventing rotation relative to the sleeve. The fastener enters the groove at the neck portion, blocking the rod.

However, the tool requires external tools for head replacement, introducing unnecessary complexity. The reliance on additional tools and complicated fastening mechanisms reduces the tool's convenience and efficiency. It also suffers from cumbersome head replacement procedures, insecure locking mechanisms, and limited versatility, hindering its effectiveness for various tasks.

The present invention is, therefore, intended to obviate or at least alleviate the problems encountered in the prior art.

### SUMMARY OF THE INVENTION

An objective of the present invention is to provide a tool with an interchangeable head, which includes a handle, a tool head, and a joining mechanism. The tool head is detachably connected to the handle. The tool head has a body extending along a first axis and an abutting portion extending along a second axis. The first axis and the second axis intersect to form an offset angle. The offset angle ranges from 30 degrees to 105 degrees. The joining mechanism is disposed between the handle and the tool head and configured to selectively permit or restrict the tool head from being detached from the handle.

In some embodiments, the tool head further includes a prying portion extending from the abutting portion along a third axis. The third axis and the second axis intersect to form an upturned angle. The upturned angle ranges from 7 degrees to 30 degrees.

In some embodiments, the prying portion includes a pair of prying claws and a prying slot formed between the pair of prying claws, and wherein each of the prying claws extends to form a wing portion on a side opposite to the prying slot.

In some embodiments, the tool head includes a first reinforcing portion extending from a bottom side of the body and having a thickness gradually decreasing from an end remote from the abutting portion toward an end adjacent thereto, and a second reinforcing portion extending on an outer side of the abutting portion from an end adjacent to the body toward the prying portion.

In some embodiments, the tool head has a plurality of ribs formed on two respective outer sides of the abutting portion. The plurality of ribs extends transversely and is equally spaced between the body and the prying portion.

In some embodiments, the body includes a first reinforcing portion extending from a bottom side thereof and having a thickness gradually increasing from an end remote from the abutting portion toward an end adjacent thereto. The abutting portion has a plurality of reinforcing recesses formed on two respective outer sides thereof. The plurality of reinforcing recesses is equally spaced between the body and the prying portion.

In some embodiments, the handle includes a receptacle hole extending along the first axis, a side hole extending in a radial direction of the first axis and communicating with the receptacle hole, and a sliding groove. The tool head has an insertion portion detachably insertable into the receptacle hole. A detent groove is formed on an outer periphery of the insertion portion in the radial direction of the first axis. The joining mechanism includes a slider and a latch member. The slider is slidably disposed within the sliding groove and configured to be slidably connected to the handle in the radial direction of the first axis between a locked position and a released position. The latch member is connected to one end of the slider and has a latch portion disposed within the side hole. When the slider is in the locked position, the latch portion engages the detent groove to restrict the tool head from departing the receptacle hole. When the slider is in the released position, the latch portion disengages from the detent groove to allow the tool head to depart the receptacle hole.

In some embodiments, the receptacle hole includes a large-diameter section and a small-diameter section along the first axis. The insertion portion includes a wide section corresponding to the large-diameter section and a narrow section corresponding to the small-diameter section.

In some embodiments, the handle further includes a receiving recess formed on a side thereof in the radial direction of the first axis and communicating with the receptacle hole. The latch member is disposed within the receiving recess. The joining mechanism further includes an elastic member and a fixing member. The elastic member sleeves the slider. One end of the elastic member abuts an inner periphery of the sliding groove and the other end thereof biases the slider toward the locked position. The fixing member passes through the latch member on a side opposite the slider and is screwed into the slider.

In some embodiments, the handle further includes a top portion in the radial direction of the first axis. The top portion has a top slot extending in a direction parallel to and communicating with the sliding groove. The joining mechanism further includes a push button and a fastener. The push button is disposed in the top slot and connected to the slider such that movement of the push button drives the slider to slide between the locked position and the released position. The fastener passes through the push button on a side opposite the slider and is screwed into the slider.

The present invention will become clearer in light of the following detailed description of illustrative embodiments of this invention described in connection with the drawings.

### BRIEF DESCRIPTION OF DRAWINGS

FIG. 1 is a perspective view of a first embodiment of a tool with an interchangeable head according to the present invention.

FIG. 2 is an exploded perspective view of the tool of FIG. 1.

FIG. 3 is a front view of the tool of FIG. 1.

FIG. 4 is a cross-sectional view of the tool of FIG. 1, showing a slider located in a locked position.

FIG. 5 is a view similar to FIG. 4, showing the slider located in a released position and the tool head detachable from a receptacle hole.

FIG. 6 is another cross-sectional view of the tool of FIG. 1, showing the slider in the locked position.

FIG. 7 is a view similar to FIG. 6, showing the slider in the released position.

FIG. 8 is a front view of a second embodiment of the tool with an interchangeable head according to the present invention.

FIG. 9 is a front view of a third embodiment of the tool with an interchangeable head according to the present invention.

FIG. 10 is a front view of a fourth embodiment of the tool with an interchangeable head according to the present invention.

FIG. 11 is a front view of a fifth embodiment of the tool with an interchangeable head according to the present invention.

FIG. 12 is a front view of a sixth embodiment of the tool with an interchangeable head according to the present invention.

FIG. 13 is a front view of a seventh embodiment of the tool with an interchangeable head according to the present invention.

### DETAILED DESCRIPTION OF THE INVENTION

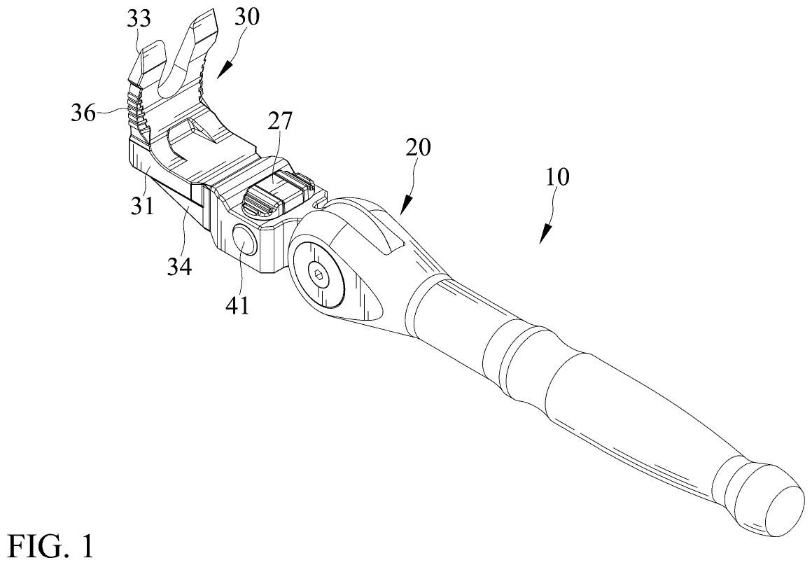

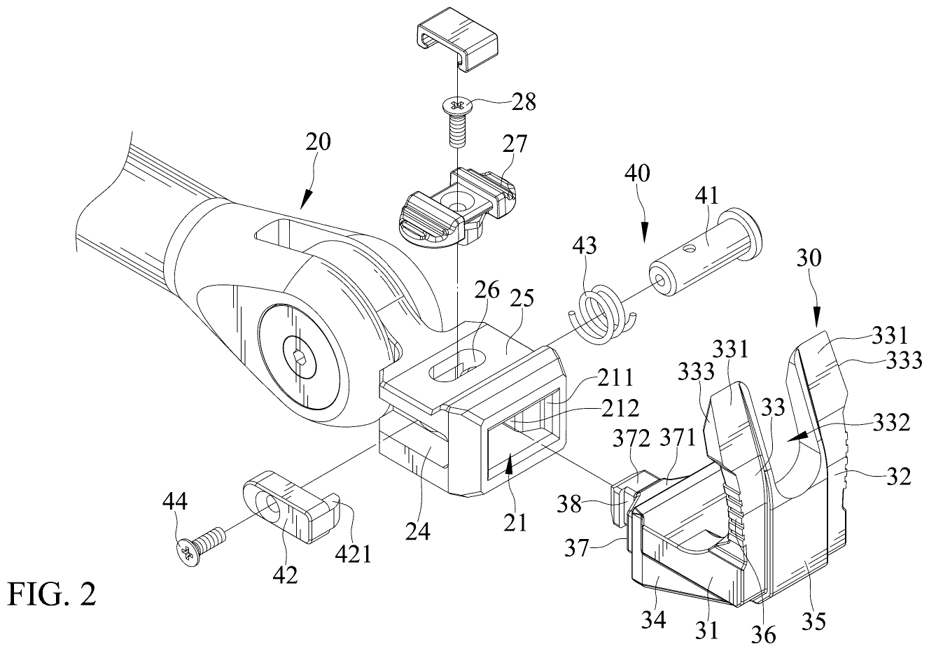

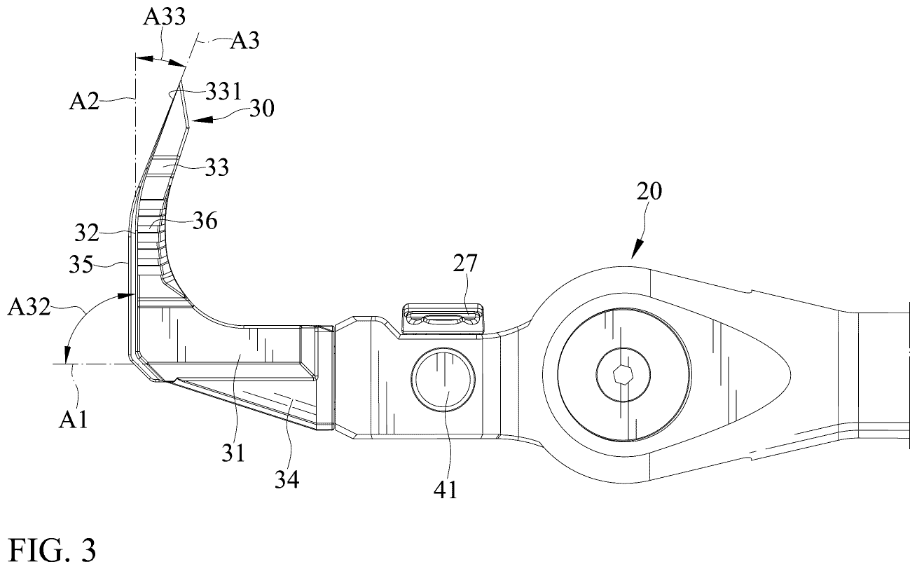

Please refer to FIGS. 1 to 7, which are a perspective view, an exploded perspective view, a front view, and cross-sectional views of a first embodiment of a tool 10 with an interchangeable head according to the present invention. The tool 10 includes a handle 20, a tool head 30, and a joining mechanism 40. The tool head 30 is detachably connected to the handle 20 and has a body 31 extending along a first axis A1 and an abutting portion 32 extending along a second axis A2. The first axis A1 and the second axis A2 intersect to form an offset angle A32, wherein the offset angle A32 ranges from 30 degrees to 105 degrees. In this embodiment, the offset angle A32 is 90 degrees. The joining mechanism 40 is disposed between the handle 20 and the tool head 30 and configured to selectively permit or restrict the tool head 30 from being detached from the handle 20.

Furthermore, the tool head 30 includes a prying portion 33 extending from the abutting portion 32 along a third axis A3. The third axis A3 and the second axis A2 intersect to form an upturned angle A33, wherein the upturned angle A33 ranges from 7 degrees to 30 degrees. In this embodiment, the upturned angle A33 is 20 degrees.

To enhance the structural strength of the tool head 30, the prying portion 33 includes a pair of prying claws 331 and a prying slot 332 formed between the pair of prying claws 331. Each of the prying claws 331 extends to form a wing portion 333 on a side opposite to the prying slot 332. The tool head 30 further includes a first reinforcing portion 34 extending from a bottom side of the body 31 and having a thickness gradually decreasing from an end remote from the abutting portion 32 toward an end adjacent thereto. The tool head 30 further includes a second reinforcing portion 35 extending on an outer side of the abutting portion 32 from an end adjacent to the body 31 toward the prying portion 33. In addition, a plurality of ribs 36 is formed on two respective outer sides of the abutting portion 32, and the plurality of ribs 36 extends transversely and is equally spaced between the body 31 and the prying portion 33.

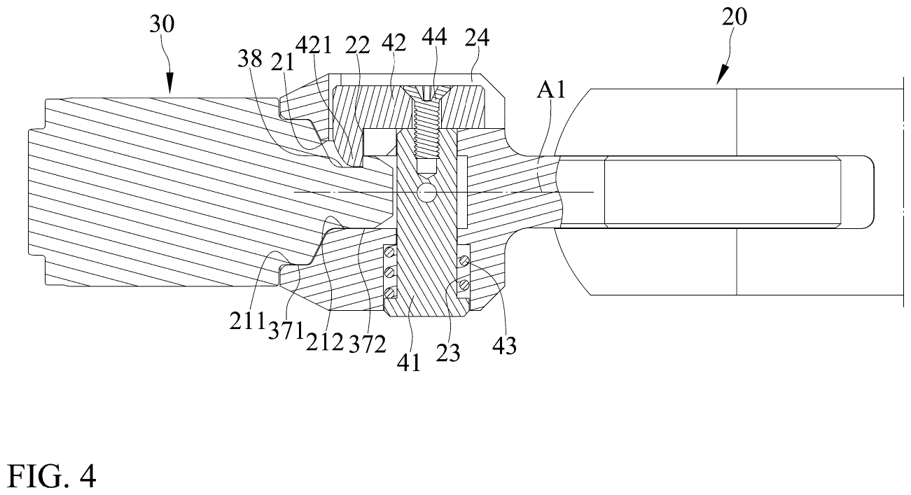

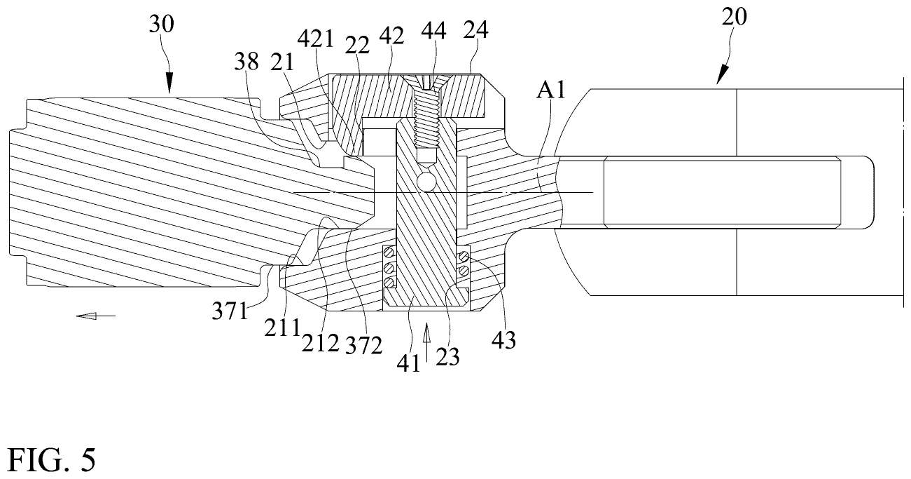

As shown in FIGS. 4 and 5, the handle 20 has a receptacle hole 21 extending along the first axis A1, a side hole 22 extending in a radial direction of the first axis A1 and communicating with the receptacle hole 21, and a sliding groove 23. The tool head 30 has an insertion portion 37 detachably insertable into the receptacle hole 21. A detent groove 38 is formed on an outer periphery of the insertion portion 37 in the radial direction of the first axis A1. The joining mechanism 40 includes a slider 41 and a latch member 42. The slider 41 is slidably disposed within the sliding groove 23 and configured to be slidably connected to the handle 20 in the radial direction of the first axis A1 between a locked position and a released position. The latch member 42 is connected to one end of the slider 41 and has a latch portion 421 disposed within the side hole 22. As shown in FIG. 4, when the slider 41 is in the locked position, the latch portion 421 engages the detent groove 38 to restrict the tool head 30 from departing the receptacle hole 21. As shown in FIG. 5, when the slider 41 is in the released position, the latch portion 421 disengages from the detent groove 38 to allow the tool head 30 to depart the receptacle hole 21.

The receptacle hole 21 includes a large-diameter section 211 and a small-diameter section 212 along the first axis A1, and the insertion portion 37 includes a wide section 371 corresponding to the large-diameter section 211 and a narrow section 372 corresponding to the small-diameter section 212, thereby forming a stepped configuration.

Furthermore, the handle 20 has a receiving recess 24 formed on a side thereof in a radial direction of the first axis A1 and communicating with the receptacle hole 21. The latch member 42 is disposed within the receiving recess 24. The joining mechanism 40 further includes an elastic member 43 sleeving the slider 41. One end of the elastic member 43 abuts an inner periphery of the sliding groove 23, and the other end biases the slider 41 toward the locked position.

To connect the latch member 42 to the slider 41, the joining mechanism 40 further includes a fixing member 44 that passes through the latch member 42 on a side opposite the slider 41 and is screwed into the slider 41.

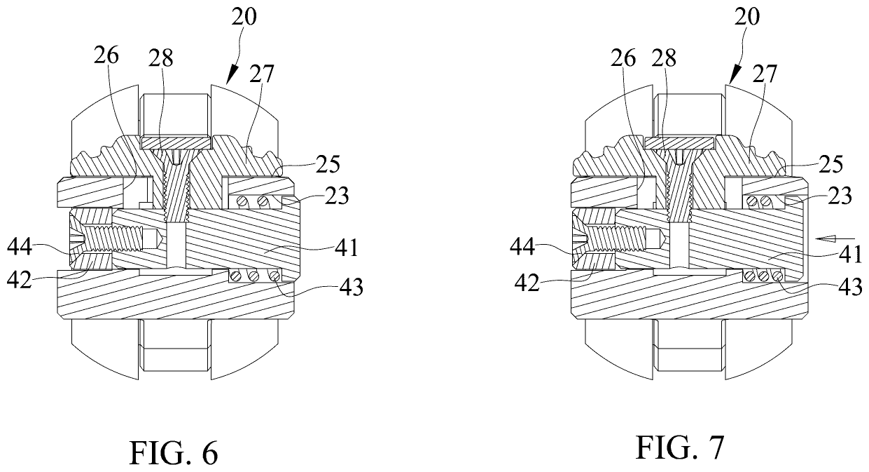

As shown in FIGS. 6 and 7, to allow the slider 41 to slide relative to the sliding groove 23 between the locked and released positions, the handle 20 has a top portion 25 in the radial direction of the first axis A1. The top portion 25 has a top slot 26 extending in a direction parallel to and communicating with the sliding groove 23. The joining mechanism 40 further includes a push button 27 and a fastener 28. The push button 27 is disposed in the top slot 26 and connected to the slider 41 such that movement of the push button 27 drives the slider 41 to slide between the locked position (FIG. 6) and the released position (FIG. 7). The fastener 28 passes through the push button 27 on a side opposite the slider 41 and is screwed into the slider 41, thereby allowing the push button 27 to drive the slider 41.

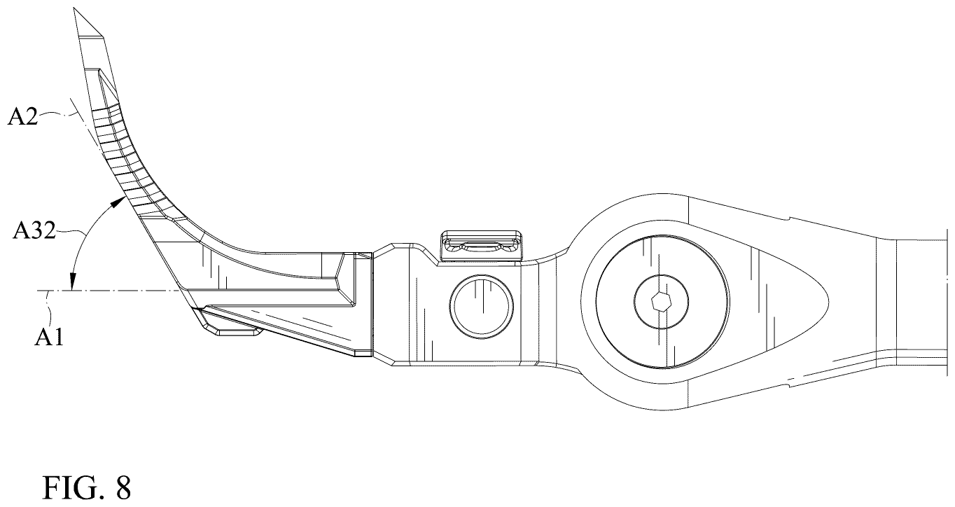

Please refer to FIG. 8, which is a front view of a second embodiment of the tool with an interchangeable head according to the present invention. The structure of this embodiment is generally similar to that of the first embodiment, except that the offset angle A32 is 60 degrees.

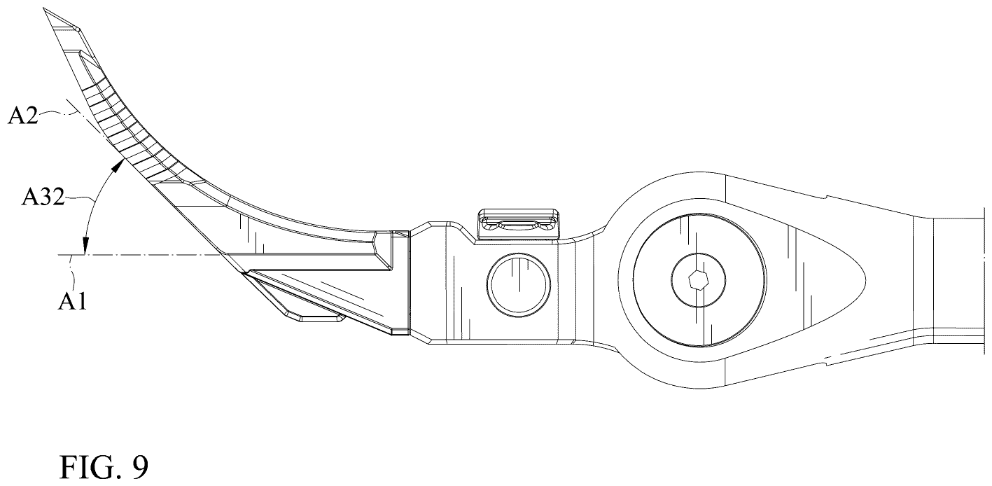

Please refer to FIG. 9, which is a front view of a third embodiment of the tool with an interchangeable head according to the present invention. The structure of this embodiment is generally similar to that of the first embodiment, except that the offset angle A32 is 45 degrees.

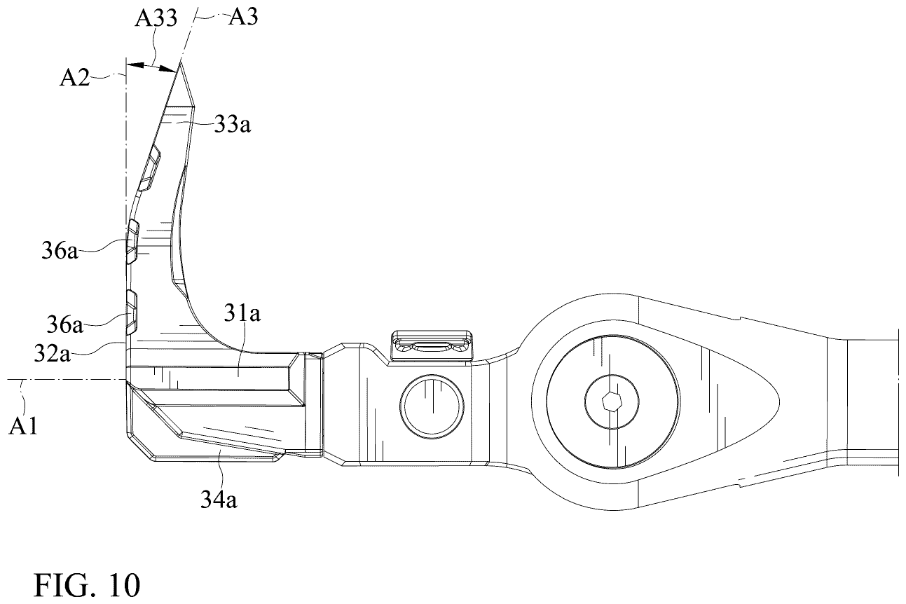

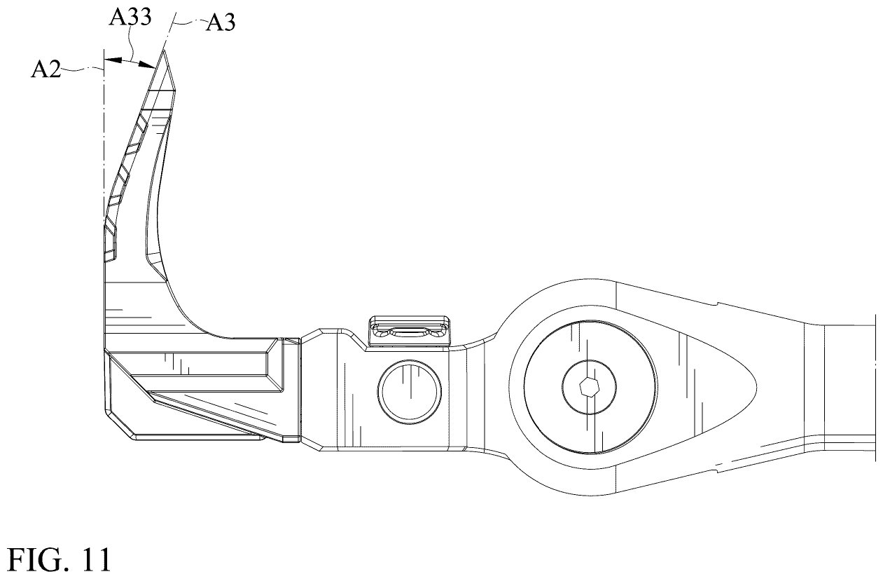

Please refer to FIG. 10, which is a front view of a fourth embodiment of the tool with an interchangeable head according to the present invention. The structure of this embodiment is generally similar to that of the first embodiment, except that the upturned angle A33 is 17 degrees, and the body 31a has a first reinforcing portion 34a extending from a bottom side thereof and having a thickness gradually increasing from an end remote from the abutting portion 32a toward an end adjacent thereto. In addition, the abutting portion 32a has a plurality of reinforcing recesses 36a formed on two respective outer sides thereof, and the plurality of reinforcing recesses 36a is equally spaced between the body 31a and the prying portion 33a, thereby improving the lateral support strength during prying.

Please refer to FIG. 11, which is a front view of a fifth embodiment of the tool with an interchangeable head according to the present invention. The structure of this embodiment is generally similar to that of the fourth embodiment, except that the upturned angle A33 is 19 degrees.

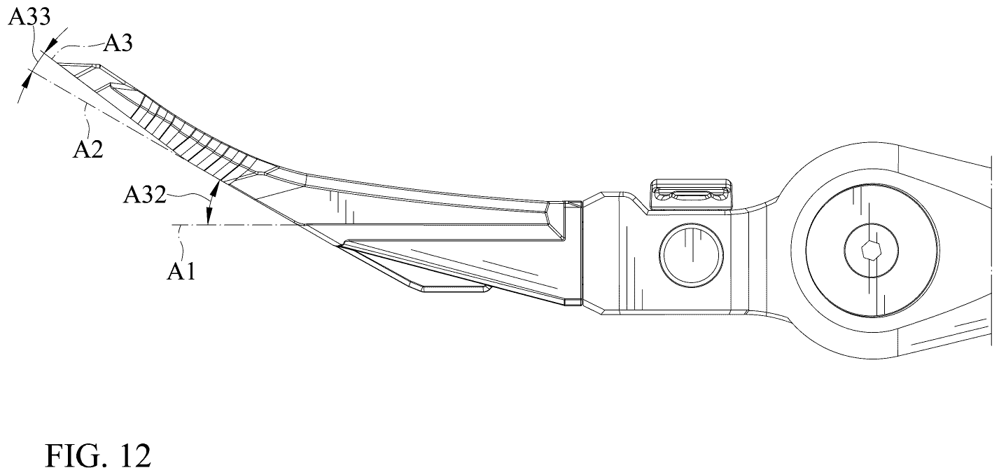

Please refer to FIG. 12, which is a front view of a sixth embodiment of the tool with an interchangeable head according to the present invention. The structure of this embodiment is generally similar to that of the first embodiment, except that the offset angle A32 is 30 degrees, and the upturned angle A33 is 7 degrees.

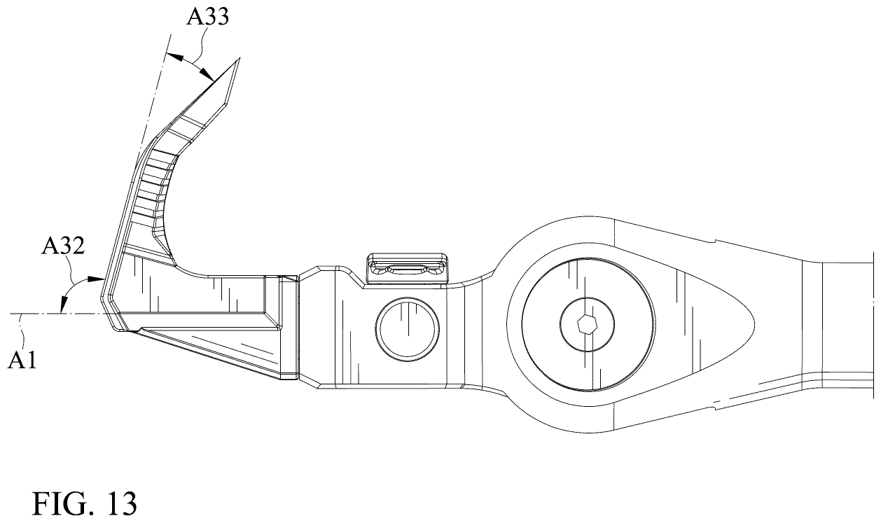

Please refer to FIG. 13, which is a front view of a seventh embodiment of the tool with an interchangeable head according to the present invention. The structure of this embodiment is generally similar to that of the first embodiment, except that the offset angle A32 is 105 degrees, and the upturned angle A33 is 30 degrees.

In summary, in the tool 10 of the present invention, the tool head 30 is detachably connected to the handle 20, and the design of the offset angle A32 between the first axis A1 and the second axis A2 allows a user to achieve a prying or pulling effect with reduced effort, thereby enhancing operation efficiency and convenience. Moreover, the arrangement of the prying portion 33, the first and second reinforcing portions 34, 35, and the ribs 36 further improves the structural strength and durability of the tool head 30. The joining mechanism 40 allows quick and convenient attachment and detachment of the tool head 30, making the tool more practical for actual use.

Although specific embodiments have been illustrated and described, numerous modifications and variations are still possible without departing from the scope of the invention. The scope of the invention is limited by the accompanying claims.

1. A tool, comprising:
a handle;
a tool head detachably connected to the handle, wherein the tool head has a body extending along a first axis and an abutting portion extending along a second axis, wherein the first axis and the second axis intersect to form an offset angle, and wherein the offset angle ranges from 30 degrees to 105 degrees; and
a joining mechanism disposed between the handle and the tool head and configured to selectively permit or restrict the tool head from being detached from the handle.

2. The tool of claim 1, wherein the tool head further includes a prying portion extending from the abutting portion along a third axis, wherein the third axis and the second axis intersect to form an upturned angle, and wherein the upturned angle ranges from 7 degrees to 30 degrees.

3. The tool of claim 2, wherein the prying portion includes a pair of prying claws and a prying slot formed between the pair of prying claws, and wherein each of the prying claws extends to form a wing portion on a side opposite to the prying slot.

4. The tool of claim 2, wherein the tool head includes a first reinforcing portion extending from a bottom side of the body and having a thickness gradually decreasing from an end remote from the abutting portion toward an end adjacent thereto, and a second reinforcing portion extending on an outer side of the abutting portion from an end adjacent to the body toward the prying portion.

5. The tool of claim 2, wherein the tool head has a plurality of ribs formed on two respective outer sides of the abutting portion, and wherein the plurality of ribs extends transversely and is equally spaced between the body and the prying portion.

6. The tool of claim 2, wherein the body includes a first reinforcing portion extending from a bottom side thereof and having a thickness gradually increasing from an end remote from the abutting portion toward an end adjacent thereto, wherein the abutting portion has a plurality of reinforcing recesses formed on two respective outer sides thereof, and wherein the plurality of reinforcing recesses is equally spaced between the body and the prying portion.

7. The tool of claim 1, wherein the handle includes a receptacle hole extending along the first axis, a side hole extending in a radial direction of the first axis and communicating with the receptacle hole, and a sliding groove;
wherein the tool head has an insertion portion detachably insertable into the receptacle hole, and wherein a detent groove is formed on an outer periphery of the insertion portion in the radial direction of the first axis;
wherein the joining mechanism includes a slider and a latch member, wherein the slider is slidably disposed within the sliding groove and configured to be slidably connected to the handle in the radial direction of the first axis between a locked position and a released position, wherein the latch member is connected to one end of the slider and has a latch portion disposed within the side hole;
wherein when the slider is in the locked position, the latch portion engages the detent groove to restrict the tool head from departing the receptacle hole; and
wherein when the slider is in the released position, the latch portion disengages from the detent groove to allow the tool head to depart the receptacle hole.

8. The tool of claim 7, wherein the receptacle hole includes a large-diameter section and a small-diameter section along the first axis, and wherein the insertion portion includes a wide section corresponding to the large-diameter section and a narrow section corresponding to the small-diameter section.

9. The tool of claim 7, wherein the handle further includes a receiving recess formed on a side thereof in the radial direction of the first axis and communicating with the receptacle hole, and wherein the latch member is disposed within the receiving recess;
wherein the joining mechanism further includes an elastic member and a fixing member, wherein the elastic member sleeves the slider, wherein one end of the elastic member abuts an inner periphery of the sliding groove and the other end thereof biases the slider toward the locked position, and wherein the fixing member passes through the latch member on a side opposite the slider and is screwed into the slider.

10. The tool of claim 7, wherein the handle further includes a top portion in the radial direction of the first axis, wherein the top portion has a top slot extending in a direction parallel to and communicating with the sliding groove;
wherein the joining mechanism further includes a push button and a fastener, wherein the push button is disposed in the top slot and connected to the slider such that movement of the push button drives the slider to slide between the locked position and the released position, and wherein the fastener passes through the push button on a side opposite the slider and is screwed into the slider.
